(19) United States
(12) Patent Application Publication
(10) Pub. No.: US 2003/0182404 A1
(43) Pub. Date: Sep. 25, 2003

(54) Installation, gateway and process for downloading information between equipment onboard an aircraft and offboard loading means

(76) Inventors: Jean-Francois Saint-Etienne, Cugnaux (FR); Jean-Louis Terme, Plaisance du Touch (FR)

Correspondence Address: Robert E. Krebs, Thelen Reid & Priest LLP, P.O. Box 640640, San Jose, CA, 95164-0640, US

(21) Appl. No.: 10/397,598

(22) Filed: Mar. 25, 2003

(30) Foreign Application Priority Data
Mar. 25, 2002 (FR) 02 03689

(51) Int. Cl. G06F 15/177; G06F 15/16

(52) U.S. Cl. 709/220; 709/249

(57) ABSTRACT

This invention relates to an installation for downloading/uploading information between at least one item of equipment (2a, 2b) onboard an aircraft, and offboard means (6) of loading/unloading information, the onboard equipment (2a, 2b) communicating through a first type A communication bus according to a first protocol P, and means (6) of loading/unloading information, communicating through a second type B communication bus using a second protocol Q.

According to the invention, the installation (1) comprises a loading/downloading information gateway (4) onboard the aircraft, capable of controlling at least one validation signal for each onboard equipment (2a, 2b), and capable of translating information according to the first protocol P into information according to the second protocol Q, and vice versa.

The invention also relates to a gateway that can be used in such an installation, and a process that can be used by this installation.

### DESCRIPTION

### CROSS REFERENCE TO RELATED APPLICATION

This application claims priority based on French Patent Application No. 02 03689 filed on Mar. 25, 2002, entitled “Installation, Gateway and Process For Downloading Information Between Equipment Onboard An Aircraft And Offboard Loading Means”.

### TECHNICAL FIELD

This invention relates to the domain of installations for downloading/uploading information between at least one item of equipment onboard an aircraft and offboard means of loading/unloading information.

The invention also relates to downloading/uploading gateways for information that can be used in such installations and processes for downloading/uploading information that can be used by these installations.

More particularly, the technical domain of the invention relates to downloading/uploading information between at least one onboard item of equipment communicating through a first type A communication bus according to a first protocol P, and comprising at least one input for reception of a downloading/uploading validation signal, and offboard means of loading/unloading information, communicating through a second type B communication bus using a second protocol Q.

### BACKGROUND THE INVENTION

In general, aircraft are fitted with many different onboard equipment and computers, some of which are connected together through communication buses so that they can exchange various information.

Most aircraft in service at the moment use communication buses to the ARINC 429 standard (ARINC for “Aeronautical Radio Inc.”). These special communication buses are based on single directional links from one sending equipment to one or more receiving equipment.

However, due to the increasing amount of equipment installed on aircraft, it is found that the use of this type of communication bus has several disadvantages. For example, one of these disadvantages is an increase in the total mass to the detriment of the transported load, increasing dimensions or an increasing probability of failure, directly resulting from the large number of existing connections.

A new type of communication bus has been developed to deal with these problems and is currently being standardised under the name ARINC 664.

This new type of communication bus is based on the use of Ethernet (LAN) type links, and is used to connect most types of equipment that have been designed so far.

Thus, it frequently happens that recently designed aircraft are outfitted with onboard equipment complying with distinct standards, with the older equipment operating according to the ARINC 429 standard and the most recent equipment operating according to the Ethernet standard.

At the same time, some aircraft with an older design in which all installed equipment communicates according to the ARINC 429 standard, may need to be upgraded and/or additions may be made to their onboard equipment. The new installed equipment may then be of any type, thus causing a diversity of standards used by equipment installed onboard aircraft, and consequently difficulties in connecting these various types of equipment.

In this respect, it is noted that the problem dealing with the diversity of standards was partially solved in document U.S. Pat. No. 5,805,828 in which an installation was proposed for an aircraft enabling communication of information between various onboard equipment, some communicating through a bus according to the ARINC 429 standard and others communicating through a bus according to the ARINC 629 standard.

However, the existence of equipment communicating through different types of communication buses leads to a second problem separate from the first problem mentioned above, related exclusively to the connection between different types of equipment within the same aircraft.

Apart from the need to communicate information between these different types of onboard equipment, at least some of this onboard equipment may be connected to offboard means of loading and/or unloading information, these means being known more generally under the term “loading terminal”.

The purpose of a loading terminal is to enable downloading and/or uploading of data or program type information to and/or from the different onboard equipments.

Concerning equipment communicating through a communication bus to the ARINC 429 standard, each equipment comprises at least one input that can receive a validate download/upload information signal, these signals being controlled through an appropriate loading terminal to which the equipment is connected. Note that these signals are activated by the loading terminal during each downloading/uploading operation of information between the terminal and the onboard equipment concerned.

On the other hand, equipment communicating through a bus complying with Ethernet standard does not include any inputs that will receive validation signals, but uses traditional two-directional Ethernet type links to communicate with an appropriate loading terminal.

According to the above, it is found that the second problem mentioned above is related to the possibility of cases in which it is necessary to download/upload information to and/or from equipment communicating through a bus according to the ARINC 429 standard, whereas the only loading terminal available is a terminal communicating through a communication bus to the Ethernet standard, designed for downloading equipment operating to the same standard. In this respect, note that the incompatibility of the standards of these two entities inevitably makes it impossible to download/upload information to and/or from the onboard equipment concerned.

Several systems have already been proposed in prior art in order to solve this problem of incompatibility between equipment onboard an aircraft and a loading terminal located on the ground.

The first of these systems is a simple combination of two loading terminals. In this case, the first terminal can firstly be connected to equipment communicating through a communication bus to the ARINC 429 standard, and secondly can control at least one validation signal for this equipment. The second loading terminal can be connected to the equipment communicating through an Ethernet type communication bus.

However, this proposed solution is very restrictive, to the extent that the total mass and the dimensions of the system are very much increased, due to the need for the presence of a second loading terminal. Furthermore, another disadvantage is due to the disparity of man/machine interfaces related to these two types of loading terminals used, which consequently introduces high costs for training personnel dealing with these two systems.

Secondly, another embodiment has also been proposed that consists of using a single loading terminal capable of communicating firstly through an ARINC 429 type of communication bus, and secondly through an Ethernet type of communication bus.

However, the proposed solution has a major disadvantage related to the specific characteristic of the loading terminal, due to the fact that it has two distinct communication interfaces. Due to unavailability reasons during aircraft stopovers, it is much preferable to be able to use a standard loading terminal rather than a specific loading terminal.

### PRESENTATION OF THE INVENTION

Therefore, the first purpose of the invention is to propose a downloading/uploading information system between at least one equipment onboard an aircraft and offboard loading/unloading means, at least one onboard equipment communicating through a first type A communication bus according to a first protocol P and comprising at least one input for reception of a validate downloading/uploading signal, the information downloading/uploading means communicating through a second type B communication bus according to a second protocol Q, this installation at least partially correcting the disadvantages related to embodiments of prior art mentioned above.

Furthermore, another purpose of the invention is to propose a downloading/uploading gateway for information that might be used in such an installation, and a process for downloading/uploading information that can be used by this installation.

To achieve this, the first purpose of the invention is an installation for downloading/uploading information between at least one equipment onboard an aircraft and offboard information loading/unloading means, at least one onboard equipment communicating through a first type A communication bus according to a first protocol P and comprising at least one reception input for a downloading/uploading validation signal, the information loading/unloading means communicating through a second type B communication bus according to a second protocol Q. According to the invention, the installation comprises a gateway for downloading/uploading information onboard the aircraft, the gateway being connectable to the loading/unloading means through a second type B communication bus, and being connected to at least one first onboard equipment communicating through a first type A communication bus, the gateway being capable of controlling at least one validation signal for each onboard equipment connected to the gateway, and translating information according to the first protocol P into information according to the second protocol Q, and vice versa.

Advantageously, the proposed installation can be used for downloading/uploading operations for information between a single offboard loading terminal with a single interface, and onboard equipment communicating through a communication bus of a type different from that used by the loading terminal. Thus, the gateway onboard the aircraft is a means for making a simple installation that is very easy to control for the personnel who will use it, since the operations to be carried out are similar to operations carried out in the presence of entities all communicating through the same type of communication bus.

According to one preferred embodiment of the invention, the information downloading/uploading gateway is also connected to at least one second onboard equipment communicating through a second type B communication bus according to the second protocol Q.

One advantage related to this specific characteristic of this preferred embodiment is to be able to download/upload information to and/or from equipment communicating through separate communication buses, through a unique downloading terminal with a single interface.

Furthermore, it would be possible for the information downloading/uploading gateway to perform routing functions and/or security functions for information communications.

Preferably, each first type A communication bus is conform with the ARINC 429 standard, and the first protocol P is conform with at least one of the elements among the group composed of the ARINC 615 standard and the ARINC 615-3 standard.

Similarly, in a preferred manner, each second type B communication bus is conform with the Ethernet standard and the second protocol Q is conform with at least one of the elements among the group composed of the ARINC 615A standard and the ARINC 665 standard.

Finally, each communication bus of the second type B may also be conform with the ARINC 629 standard.

Another purpose of the invention is an information downloading/uploading gateway between at least one first equipment onboard an aircraft and information loading/unloading means offboard the aircraft. According to the invention, the gateway is onboard the aircraft and can be connected firstly to at least one first onboard equipment communicating through a communication bus of the first type A according to a first protocol P and comprising at least one reception input for a downloading/uploading validation signal, and secondly information loading/unloading means through a second type B communication bus according to a second protocol Q, the gateway being capable of controlling at least one downloading/uploading validation signal for each first onboard equipment connected to the gateway, and translating the information according to the first protocol P into information according to the second protocol Q, and vice versa.

Furthermore, the invention also relates to an information downloading/uploading process between at least one first equipment onboard an aircraft and information loading/unloading means offboard the aircraft, at least one first onboard equipment communicating through a first type A communication bus according to a first protocol P and comprising at least one reception input for a downloading/uploading validation signal, the information loading/unloading means communicating through a second type B communication bus according to a second protocol Q. According to the invention, the information to be downloaded/uploaded passes through an information downloading/uploading gateway onboard the aircraft, the gateway controlling at least one validation signal for each first onboard equipment communicating through a first type A communication bus and translating this information according to a first protocol P into information according to the second protocol Q, and vice versa.

Other advantages and characteristics of the invention will become clear in the detailed description given below that is not in any way limitative.

### BRIEF DESCRIPTION OF THE DRAWINGS

This description will be made with reference to the attached drawings in which:

FIG. 1 shows a diagrammatic view of an information downloading/uploading installation according to a first preferred embodiment of the invention,

FIG. 2 represents a diagrammatic view of an information downloading/uploading gateway used in the installation shown in FIG. 1, and

FIG. 3 shows a diagrammatic view of an information downloading/uploading installation according to a second preferred embodiment of the invention.

### DETAILED DESCRIPTION OF THE PREFERRED EMBODIMENTS

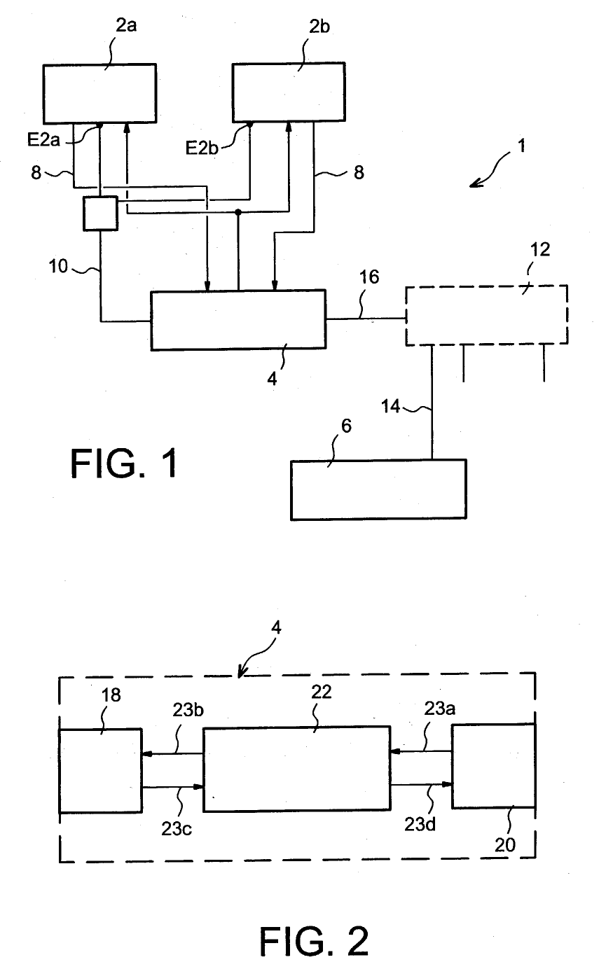

FIG. 1 represents a diagrammatic view of an information downloading/uploading installation 1 according to a first preferred embodiment of the invention.

In the remainder of the description, the term “downloading” will refer to downloading operations for data or program type information, and also uploading operation of the same nature.

The installation 1 comprises at least one first equipment 2a, 2b onboard the aircraft (not shown), an information downloading gateway also onboard the aircraft, and offboard information loading means 6, also called loading terminal. It is noted that only the first two items of onboard equipment 2a, 2b are shown in FIG. 1, but the installation 1 could naturally comprise more than two.

In this preferred embodiment of the invention, all the first onboard equipment 2a, 2b is designed to communicate through a communication bus according to the ARINC 429 standard, and according to a protocol conform with the ARINC 615 and/or ARINC 615-3 standard and/or any other version of the ARINC 615 standard. Furthermore, each of the first items of equipment 2a, 2b, comprises an input ?E2a and ?E2b respectively, into which a downloading validation signal can be input, this signal being activated throughout the duration of an information downloading operation.

Each first equipment 2a, 2b is connected to the gateway 4 through a communication bus 8 conform with the ARINC 429 standard. This type of bus uses single directional type links from a transmitting element, to one or several receiving elements.

Furthermore, to make it possible to download data to a first onboard equipment 2a, 2b, the gateway 4 is also connected to the validation signal inputs ?E2a, ?E2b on the first equipment 2a, 2b, through cables 10.

On the other hand, the loading terminal 6 is capable of communicating through a communication bus to the Ethernet standard also called the ARINC 664 standard, and according to a protocol conform with ARINC 615A and/or ARINC 665 standards. Therefore, the loading terminal 6 is connected to means 12 such as a switch usually used in Ethernet networks, or a hub, through a communication bus 14 conform with the Ethernet standard.

In the same way, the downloading gateway 4 is also connected to means 12 through a communication bus 16 conform with the Ethernet standard.

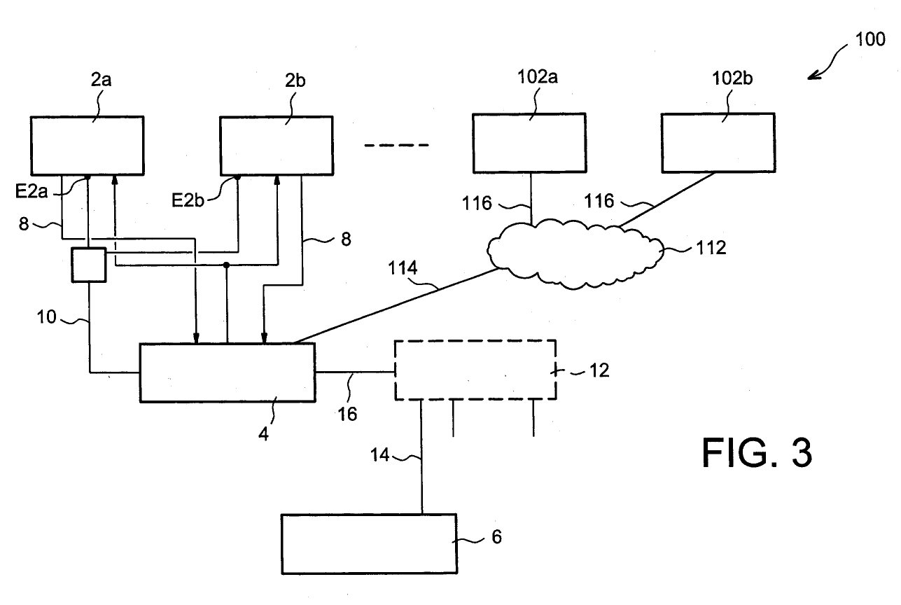

FIG. 2 shows a diagrammatic view of the downloading gateway 4 used in this preferred embodiment of the invention capable of controlling at least one validation signal for each first onboard equipment 2a, 2b in the installation 1.

The gateway 4 comprises first information reception means 18, and second information reception means 20. The first means 18 can receive information according to the protocol conform with the ARINC 615 and/or ARINC 615-3 standards and are directly coupled to communication buses 8 conform with the ARINC 429 standard. Similarly, the second means 20 are capable of receiving information according to the protocol conform with the ARINC 615A and/or ARINC 665 standards, and are directly coupled to the communication bus 16 conform with the Ethernet standard.

Furthermore, the downloading gateway 4 is provided with translation means 22 capable of translating information according to the protocol conform with the ARINC 615 and/or 615A and/or ARINC 665 standards and vice versa. The translation means 22 are thus connected to the first and second information reception means 18, 20 through single-directional connections 23a, 23b, 23c and 23d.

The installation 1 can operate as follows.

When the aircraft is in stopover and some of its first onboard equipment 2a, 2b have to download data, the first step is to connect the onboard downloading gateway 4 to the offboard loading terminal 6, as described above.

If the data are downloaded from the loading terminal 6 to one or more first items of equipment 2a, 2b onboard the aircraft, the information output from the terminal 6 passes along the communication bus 14, into the switch type means 12, and then arrives in the second information reception means 20 of the gateway 4, through the communication bus 16.

By using the link 23a, the information transported according to the protocol conform with the ARINC 615A and/or ARINC 665 standards enters into the translation means 22 where it is translated into information according to the protocol conform with the ARINC 615 and/or ARINC 615-3 standards. As it circulates through link 23b, the information reaches the first information reception means 18 before passing through the communication buses 8 to deliver this information to the various first onboard equipment 2a, 2b concerned.

Similarly, if data are uploaded from a first equipment 2a, 2b onboard the aircraft to the loading terminal 6, information output from the first equipment 2a, 2b circulates in the communication buses 8, and then arrives in the first information reception means 18 on the gateway 4.

Using link 23c, the information circulating according to the protocol conform with the ARINC 615 and/or ARINC 615-3 standards is input into the translation means 22 where it is translated into information according to the protocol conform with the ARINC 615A and/or ARINC 665 standards. As it circulates through the link 23d, the information reaches the second information reception means 20 before transiting through the communication buses 14 and 16 and switch type means 12, to deliver this information to the loading terminal 6 of the installation 1.

Obviously, as mentioned above, note that the downloading and uploading operations are made possible by the downloading gateway 4 which, apart from its information translation function, can also control validation signals for the different first items of equipment 2a, 2b.

The downloading gateway 4, and particularly the translation means 22, can perform several functions.

Among these functions, there are firstly functions related to the possibility of building up configuration files specific to each first onboard equipment 2a, 2b connected to the downloading gateway 4.

Furthermore, the gateway 4 is capable of responding to identification queries (such as SNIP) “Simple Network Identification Protocol” made according to a protocol complying with the ARINC 615A and/or ARINC 665 standards, these queries being addressed to the first onboard equipment 2a, 2b connected to the gateway 4 through a communication bus conform with the ARINC 429 standard. It is noted that a response to this type of identification request is sent either directly by the first onboard equipment 2a, 2b, or using information previously recorded in the downloading gateway 4.

Furthermore, the gateway 4 is also capable of emulating an operation to transmit information formulated according to a protocol conform with ARINC 615A and/or ARINC 665 standards, these queries addressing the first onboard equipment 2a, 2b connected to the gateway 4 through a communication bus conform with the ARINC 429 standard. Note that the expected response is sent either directly through the onboard equipment 2a, 2b, or from information previously recorded in the downloading gateway 4.

In terms of functions that can be fulfilled by the downloading gateway 4, information about the state of the downloading operation in progress can also be transmitted to the loading terminal 6. Furthermore, for some information for which a display is necessary and which is sent from a first onboard terminal 2a, 2b communicating through a communication bus conform with the ARINC 429 standard, the gateway 4 can translate this information so that it can display it on a man/machine interface of the loading terminal 6. The loading gateway 4 is also capable of carrying out an abort operation of the current downloading, the command for this abort operation being output from the loading terminal 6, for downloading related to a first onboard equipment 2a, 2b communicating through an ARINC 429 communication bus.

Note that the loading gateway 4 itself can be downloaded, for example using the loading terminal 6, particularly to perform all the above-mentioned functions. Thus, after this downloading type, information received by the loading gateway 4 is intended exclusively for it to the extent that it is never redirected towards other entities and its main purpose is to enable correct operation of this gateway 4. Information downloaded towards the loading gateway 4 may also enable modifications to its behaviour, and there are many types such as information about the protocols used, executable programs, or configuration tables.

FIG. 3 shows an information downloading installation 100 according to a second preferred embodiment of the invention.

The installation 100 comprises at least one first equipment 2a, 2b onboard an aircraft (not shown), an information downloading gateway 4 also onboard the aircraft and offboard information loading means 6, also called the loading terminal. Note that only the first two items of onboard equipment 2a, 2b are shown in FIG. 3, but naturally the installation 100 could comprise more than two.

The communication buses used to connect these various elements together are exactly the same as those used in the installation 1 according to the first preferred embodiment of the invention, and therefore will not be described further. Similarly, operation of the installation 100 is identical to operation of the installation 1 for all elements common to these two embodiments, and therefore it will not be described further.

However, in the second preferred embodiment, the installation 100 comprises second onboard equipment 102a, 102b, with a function similar to the first onboard equipment 2a, 2b, with the difference that they can communicate through a communication bus conform with Ethernet standard and according to a protocol conform with the ARINC 615A and/or ARINC 665 standards, in the same way as the loading terminal 6.

The second onboard equipment 102a, 102b is connected to the loading gateway 4 through a communication bus 114, 116 creating links with a network 112 that may comprise several hub type means.

Thus, information output from the loading terminal 6 according to the ARINC 615A and/or ARINC 665 protocol towards the second onboard equipment 102a, 102b, does not need to pass through the translation means 22 of the gateway 4, and is redirected directly to the Ethernet type communication bus 114. In this case, a single loading terminal 6 is sufficient to download information to first onboard equipment 2a, 2b and to second onboard equipment 102a, 102b, operating according to the ARINC 429 standard and the Ethernet standard respectively.

Apart from the functions already mentioned above related to the downloading gateway 4, the downloading gateway may also be used to perform various functions in the two preferred embodiments described. These functions include routing functions, for example an IP (Internet Protocol) type routing function, or functions to increase the security of information communication, consisting for example of checking equipment, computer, and terminal addresses authorized to communicate with the different equipment to be downloaded.

Note also that in the described preferred embodiments, the first onboard equipment 2a, 2b communicates through an ARINC 429 type communication bus, and the second onboard equipment 102a, 102b and the loading terminal 6 communicate through an Ethernet type communication bus. However, the invention also relates to installations for which the elements used can operate according to standards other than those specifically mentioned. For example, the second onboard equipment 102a, 102b and the loading terminal 6 may de designed to communicate through the communication bus according to the ARINC 629 standard.

Finally, it could also be planned that the downloading gateway 4 could have an input to be connected to a loading terminal communicating according to a communication bus conform with the ARINC 429 standard, or that this gateway 4 can be easily extracted to enable easy and direct connections between the first onboard equipment 2a, 2b and such a loading terminal.

Obviously, those skilled in the art could make various modifications to the installations 1 and 100 described above, which are only given as non-limitative examples.

1. Installation for downloading/uploading information between at least one first equipment onboard an aircraft and offboard information loading/unloading means, at least one onboard equipment communicating through a first type A communication bus according to a first protocol P and comprising at least one reception input for a downloading/uploading validation signal, the information loading/unloading means communicating through a second type B communication bus according to a second protocol Q, characterized in that the installation comprises a gateway for downloading/uploading information onboard the aircraft, the said gateway being connectable to the loading/unloading means through a second type B communication bus, and being connected to at least one first onboard equipment communicating through a first type A communication bus, the said gateway being capable of controlling at least one validation signal for each onboard equipment connected to the said gateway, and capable of translating information according to the first protocol P into information according to the second protocol Q, and vice versa.

2. Installation according to claim 1, characterized in that the information downloading/uploading gateway is also connected to at least one second onboard equipment communicating through a second type B communication bus according to the second protocol Q, through a second type B communication bus according to the said second protocol Q.

3. Installation according to claim 1, characterized in that the information downloading/uploading gateway can be used to perform routing functions.

4. Installation according to claim 1, characterized in that the information downloading/uploading gateway can be used to perform security functions for information communications.

5. Installation according to claim 1, characterized in that the information downloading/uploading gateway can be used to download information intended exclusively for it.

6. Installation according to claim 1, characterized in that each first type A communication bus is conform with ARINC 429 standard, and in that the said first protocol P is conform with at least one of the elements among the group composed of the ARINC 615 standard and the ARINC 615-3 standard.

7. Installation according to claim 1, characterized in that each second type B communication bus is conform with the Ethernet standard, and in that the said second protocol Q is conform with at least one of the elements among the group composed of the ARINC 615A standard and the ARINC 665 standard.

8. Installation according to claim 1, characterized in that each second type B communication bus is conform with the ARINC 629 standard.

9. Gateway for downloading/uploading information between at least one equipment onboard an aircraft, and offboard information loading/unloading means, characterized in that this gateway is onboard the aircraft and is connectable to at least one first onboard equipment communicating through a first type A communication bus according to a first protocol P and comprising at least one reception input for a downloading/uploading validation signal, and to means of loading/unloading information through a second type B communication bus according to the second protocol Q, the said gateway being capable of controlling at least one loading/unloading information validation signal for each first onboard equipment connected to the said gateway, and capable of translating information according to the said first protocol P into information according to the said second protocol Q, and vice versa.

10. Gateway according to claim 9, characterized in that it is connectable to at least one second onboard equipment communicating through a second type B communication bus according to the said second protocol Q, through a second type B communication bus according to the said second protocol Q.

11. Gateway according to claim 9, characterized in that it can perform routing functions.

12. Gateway according to claim 9, characterized in that it can perform security functions for information communications.

13. Gateway according to claim 9, characterized in that it can be used to download information intended exclusively for it.

14. Gateway according to claims 9, characterized in that each first type A communication bus is conform with the ARINC 429 standard, and in that the first said protocol P is conform with at least one of the elements among the group composed of the ARINC 615 standard and the ARINC 615-3 standard.

15. Gateway according to claim 9, characterized in that each second type B communication bus is conform with the Ethernet standard and in that the second said protocol Q is conform with at least one of the elements among the group composed of the ARINC 615A standard and the ARINC 665 standard.

16. Gateway according to claim 9, characterized in that each communication bus of the second type B is conform with the ARINC 629 standard.

17. Method for downloading/uploading information between at least one equipment onboard an aircraft, and offboard information loading/unloading means, at least a first onboard equipment communicating through a first type A communication bus according to a first protocol P and comprising at least one reception input for a downloading/uploading validation signal, the said information loading/unloading means communicating through a second type B communication bus according to a second protocol Q, characterized in that information is downloaded/uploaded using a downloading/uploading gateway onboard the aircraft, the said gateway controlling at least one validation signal for each first onboard equipment communicating through a first type A communication bus, and translating information according to the first protocol P into information according to the second protocol Q, and vice versa.

18. Method according to claim 17, characterized in that information passes through the said information downloading/uploading gateway, between at least one second onboard equipment communicating through a second type B communication bus according to the said second protocol Q, and information loading/downloading means.

19. Method according to claim 17, characterized in that the information loading/downloading gateway performs routing functions.

20. Method according to claim 17, characterized in that the information loading/downloading gateway performs security functions for information communications.

21. Method according to claim 17, characterized in that the information loading/downloading gateway can be used to download information intended exclusively for it.

22. Method according to claim 17, characterized in that a communication bus conform with ARINC 429 standard is used for each first type A communication bus, and in that the said first protocol P is conform with at least one of the elements among the group composed of the ARINC 615 standard and the ARINC 615-3 standard.

23. Method according to claim 17, characterized in that a communication bus conform with Ethernet standard is used for each second type B communication bus, and in that the said second protocol Q is conform with at least one of the elements among the group composed of the ARINC 615A standard and the ARINC 665 standard.

24. Method according to claim 17, characterized in that a communication bus conform with the ARINC 629 standard is used for each second type B communication bus.
